(19) United States
(12) Patent Application Publication
(10) Pub. No.: US 2013/0176009 A1
(43) Pub. Date: Jul. 11, 2013

(54) SMART LOW DROP-OUT VOLTAGE REGULATOR AND ASSOCIATED METHOD

(71) Applicants: Eric Yang, Saratoga, CA (US); Zheng Luo, Santa Clara, CA (US)

(72) Inventors: Eric Yang, Saratoga, CA (US); Zheng Luo, Santa Clara, CA (US)

(73) Assignee: Monolithic Power Systems, Inc., San Jose, CA (US)

(21) Appl. No.: 13/347,378

(22) Filed: Jan. 10, 2012

(51) Int. Cl. G05F 1/10

(52) U.S. Cl. 323/274

(57) ABSTRACT

The present disclosure discloses a low drop-out voltage regulator and an electronic device comprising the same. The present disclosure also discloses a method for converting a power supply voltage to a regulated output voltage. The low drop-out voltage regulator comprises a pass device controllable to convert a power supply voltage to a regulated output voltage; and a controller configured to receive an input signal and to provide a driving signal to the control terminal of the pass device based on the input signal, wherein when the input signal is within a predetermined range, the driving signal turns the pass device ON, and the power supply voltage charges the output voltage; and wherein when the input signal is without the predetermined range, the driving signal turns the pass device OFF, and the power supply voltage stops charging the output voltage.

### TECHNICAL FIELD

This disclosure relates generally to power management circuits, and particularly relates to low drop-out voltage regulators.

### BACKGROUND

Most electronic devices operate at regulated and stable voltages. In particular, most semiconductor based electronic devices operate at relatively low direct current (“DC”) voltages, for example DC voltages lower than 12 volts. However, much of the electrical energy to power electronic devices is made available at substantially higher voltages. For example, residential electrical power in the United States is an alternate current (“AC”) voltage nominally rated at 120 volts, and in China is an AC voltage nominally rated at 220 Volts.

Generally power supplies are employed to provide appropriate supply voltages for electronic devices. Typically, a power supply may comprise a voltage regulator to convert a relatively high voltage into a relatively low and regulated voltage suitable for powering electronic devices. One type of commonly used voltage regulators comprises a low drop-out voltage regulator (“LDO”). The operation of the low drop-out voltage regulator is based on feeding back an amplified difference signal between its output voltage and a desired value, which is used to control an output current flow of a pass device (such as a power transistor) driving a load. The drop-out voltage is the value of the input/output differential voltage lost during feedback regulation.

A low drop-out voltage regulator may be used alone to provide power. A low drop-out voltage regulator may also be integrated into an integrated circuit (“IC”) such as a driver or a power converter etc. to provide an appropriate operating voltage required by other circuit elements in the integrated circuit from a high voltage power bus (e.g. a high-voltage AC power bus). However, since the voltage of the high voltage power bus may vary largely under different conditions, a traditional low drop-out voltage regulator usually consume a lot of power and may even cause thermal problems. For example, in most high-voltage applications wherein the voltage of the high-voltage power bus may be as high as several hundreds volts, the possibility to connect a traditional low drop-out voltage regulator to the high voltage power bus is normally limited by the thermal handling capability of the IC package.

Sometimes, a power resistor and a zenor diode may be used to replace a low drop-out voltage regulator to provide a desired voltage from a high voltage power bus. However, the power consumed on the power resistor may also be very high.

A need therefore exists for a low drop-out voltage regulator wherein the abovementioned disadvantage(s) may be alleviated.

### SUMMARY

In accomplishing the above and other objects, there has been provided, in accordance with an embodiment of the present disclosure, a low drop-out voltage regulator, comprising: an input terminal configured to receive a power supply voltage; an output terminal configured to provide an output voltage; a pass device having a first terminal, a second terminal and a control terminal, wherein the first terminal is coupled to the input terminal, and wherein the second terminal is coupled to the output terminal; and a controller comprising an input terminal configured to receive an input signal, and an output terminal configured to provide a driving signal to the control terminal of the pass device based on the input signal, wherein the driving signal turns the pass device ON when the input signal is within a predetermined range; and wherein the driving signal turns the pass device OFF when the input signal is without the predetermined range.

In addition, there has been provided, in accordance with an embodiment of the present disclosure, a method for converting a power supply voltage to a regulated output voltage, comprising: providing the power supply voltage to a first terminal of a pass device, wherein the pass device further comprises a second terminal and a control terminal; and controlling the pass device to provide the regulated output voltage at the second terminal; wherein controlling the pass device comprises: comparing an input signal related to the power supply voltage and/or the output voltage with a predetermined range to generate a driving signal having an enable logic state and a disable logic state, wherein the driving signal is at the enable logic state when the input signal is within the predetermined range, and wherein the driving signal is at the disable logic state when the input signal is without the predetermined range; providing the driving signal to the control terminal of the pass device; and turning the pass device ON when the driving signal is at the enable logic state, and turning the pass device OFF when the driving signal is at the disable logic state.

### BRIEF DESCRIPTION OF THE DRAWINGS

The following detailed description of various embodiments of the present invention can best be understood when read in conjunction with the following drawings, in which the features are not necessarily drawn to scale but rather are drawn as to best illustrate the pertinent features.

FIG. 1 illustrates a schematic diagram of a low drop-out voltage regulator 100 in accordance with an embodiment of the present invention.

FIG. 2 illustrates a schematic diagram of a low drop-out voltage regulator 200 in accordance with another embodiment of the present invention.

FIG. 3 illustrates a schematic diagram of a first control circuit in accordance with an embodiment of the present invention.

FIG. 4 illustrates a schematic diagram of a first comparison circuit in accordance with an embodiment of the present invention.

FIG. 5 illustrates a schematic diagram of a low drop-out voltage regulator 300 in accordance with another embodiment of the present invention.

FIG. 6 illustrates a schematic diagram of a second control circuit in accordance with an embodiment of the present invention.

FIG. 7 illustrates a schematic diagram of a second comparison circuit in accordance with an embodiment of the present invention.

FIGS. 8A and 8B illustrate schematic diagrams of low drop-out voltage regulators 400 in accordance with embodiments of the present invention.

FIGS. 9A and 9B illustrate schematically operating waveform diagrams of the low drop-out voltage regulator 400 in accordance with embodiments of the present invention.

FIG. 10 illustrates schematically a low drop-out voltage regulator 500 in accordance with another embodiment of the present invention.

FIG. 11 illustrates a top plane view of a package 700 in which the pass device 103 and the controller 104 are encapsulated in an encapsulant in accordance with an embodiment of the present invention.

FIG. 12 illustrates a top plane view of a package 800 in which the pass device 103 and the controller 104 are encapsulated in an encapsulant in accordance with another embodiment of the present invention.

FIG. 13 illustrates schematically an electronic circuit 600 comprising a low drop-out voltage regulator in accordance with an embodiment of the present invention.

FIG. 14 shows a flow chart illustrating a method for converting a power supply voltage to a regulated output voltage in accordance with an embodiment of the present invention.

The use of the same reference label in different drawings indicates the same or like components or structures with substantially the same functions for the sake of simplicity.

### DETAILED DESCRIPTION

Various embodiments of the present invention will now be described. In the following description, some specific details, such as example circuits and example values for these circuit components, are included to provide a thorough understanding of embodiments. One skilled in the relevant art will recognize, however, that the present invention can be practiced without one or more specific details, or with other methods, components, materials, etc. In other instances, well-known structures, materials, processes or operations are not shown or described in detail to avoid obscuring aspects of the present invention.

Throughout the specification and claims, the term “coupled,” as used herein, is defined as directly or indirectly connected in an electrical or non-electrical manner. The terms “a,” “an,” and “the” include plural reference, and the term “in” includes “in” and “on”. The phrase “in one embodiment,” as used herein does not necessarily refer to the same embodiment, although it may. The term “or” is an inclusive “or” operator, and is equivalent to the term “and/or” herein, unless the context clearly dictates otherwise. The term “based on” is not exclusive and allows for being based on additional factors not described, unless the context clearly dictates otherwise. The term “circuit” means at least either a single component or a multiplicity of components, either active and/or passive, that are coupled together to provide a desired function. The term “signal” means at least one current, voltage, charge, temperature, data, or other signal. Where either a field effect transistor (“FET”) or a bipolar junction transistor (“BJT”) may be employed as an embodiment of a transistor, the scope of the words “gate”, “drain”, and “source” includes “base”, “collector”, and “emitter”, respectively, and vice versa. Those skilled in the art should understand that the meanings of the terms identified above do not necessarily limit the terms, but merely provide illustrative examples for the terms.

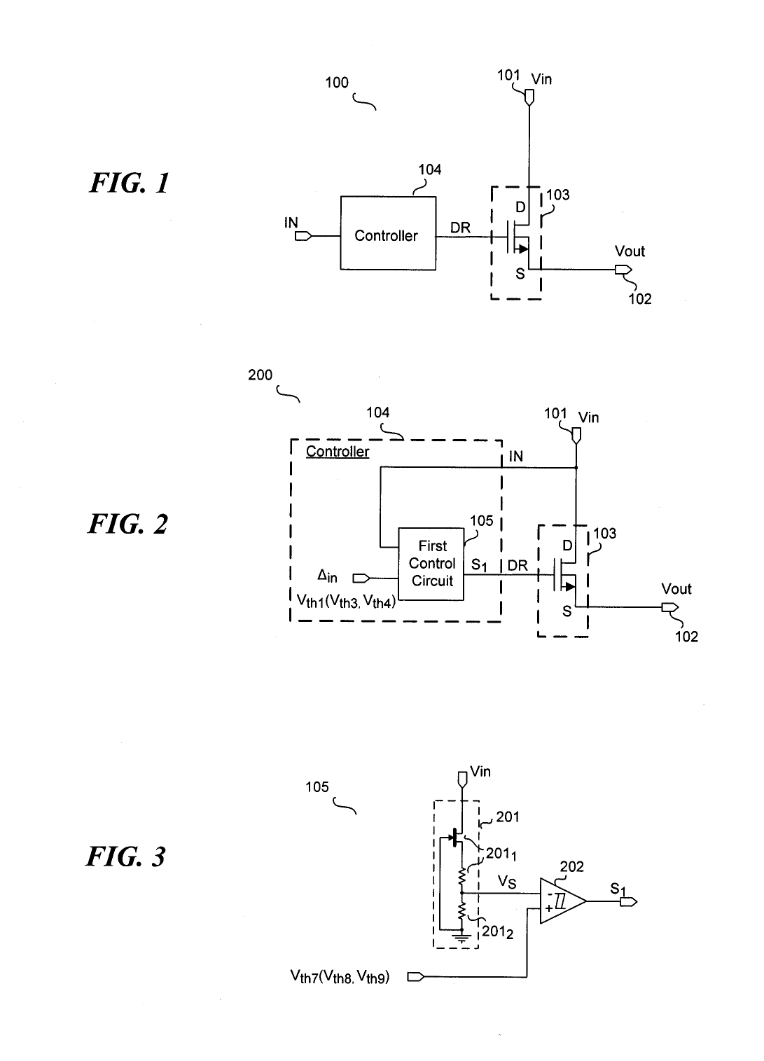

FIG. 1 illustrates a schematic diagram of a low drop-out voltage regulator 100 in accordance with an embodiment of the present invention. The low drop-out voltage regulator 100 comprises an input terminal 101 configured to receive a power supply voltage Vin; an output terminal 102 configured to provide an output voltage Vout; a pass device 103 having a first terminal D, a second terminal S and a control terminal G, wherein the first terminal D is coupled to the input terminal 101, and wherein the second terminal S is coupled to the output terminal 102; and a controller 104 comprising an input terminal IN configured to receive an input signal, and an output terminal configured to provide a driving signal DR to the control terminal G of the pass device 103 based on the input signal IN, wherein the driving signal DR turns the pass device 103 ON and OFF to generate the output voltage Vout at the second terminal S of the pass device 103, and wherein the driving signal DR turns the pass device 103 ON when the input signal IN is within a predetermined range; and wherein the driving signal DR turns the pass device 103 OFF when the input signal IN is without the predetermined range.

In one embodiment, the driving signal DR may comprise an enable logic state and a disable logic state, wherein the driving signal DR is at the enable logic state when the input signal IN is within the predetermined range; and wherein the driving signal DR is at the disable logic state when the input signal IN is without the predetermined range; and wherein the driving signal DR turns the pass device 103 ON when the driving signal DR is at the enable logic state; and wherein the driving signal DR turns the pass device 103 OFF when the driving signal DR is at the disable logic state.

In one embodiment, the pass device 103 may comprise a high-voltage semiconductor device controllable to be turned ON or OFF in response to a control signal applied at the control terminal. For example, the pass device 103 may comprise a high-voltage transistor such as a high-voltage metal oxide semiconductor field effect transistor (“MOSFET”), a high-voltage bipolar junction transistor (“BJT”), a high-voltage double diffused metal oxide semiconductor field effect transistor (“DMOS”), a high-voltage junction field effect transistor (“JFET”) etc. and/or combinations thereof.

FIG. 2 illustrates a schematic diagram of a low drop-out voltage regulator 200 in accordance with another embodiment of the present invention. Components or structures in the low drop-out voltage regulator 200 with substantially the same functions as those of the low drop-out voltage regulator 100 are identified by the same reference labels as used in the low drop-out voltage regulator 100 for the sake of simplicity. As illustrated in FIG. 2, the input signal IN may comprise the power supply voltage Vin, and the predetermined range may comprise a first predetermined range Δᵢₙ.

In one embodiment, still referring to FIG. 2, the controller 104 may comprise a first control circuit 105 having a first input terminal configured to receive the power supply voltage Vin, a second input terminal configured to receive a first threshold voltage Vₜₕ₁, and an output terminal configured to provide a first control signal S₁ having an enable logic state and a disable logic state, wherein the first control signal S₁ is at the enable logic state when the power supply voltage Vin is lower than the first threshold voltage Vₜₕ₁, and wherein the first control signal S₁ is at the disable logic state when the power supply voltage Vin is higher than the first threshold voltage Vₜₕ₁, and wherein the first control signal S₁ may constitute the driving signal DR, and wherein the driving signal DR turns the pass device ON when the first control signal S₁ is at the enable logic state, and wherein the driving signal DR turns the pass device OFF when the first control signal S₁ is at the disable logic state.

In this case, the first predetermined range Δᵢₙ is substantially controlled between ground potential and the first threshold voltage Vₜₕ₁.

In one embodiment, the controller 104 may further comprise a logic driving circuit such as a driver (not shown) configured to receive the first control signal S₁ and to convert the first control signal S₁ into the driving signal DR. The logic driving circuit in this case is usually provided to improve the driving capability of the driving signal DR.

In one embodiment, the first threshold voltage Vₜₕ₁ may comprise a third threshold voltage Vₜₕ₃ and a fourth threshold voltage Vₜₕ₄, wherein the fourth threshold voltage Vₜₕ₄ has a first predetermined hysteresis from the third threshold voltage Vₜₕ₃, and wherein the first control signal S₁ is at the enable logic state when the power supply voltage Vin is lower than the third threshold voltage Vₜₕ₃, and wherein the first control signal S₁ is at the disable logic state when the power supply voltage Vin is higher than the fourth threshold voltage Vₜₕ₄.

In one embodiment, the fourth threshold voltage Vₜₕ₄ is higher than the third threshold Vₜₕ₃ thereby providing a hysteresis for the first control signal S₁'s changing from the enable logic state to the disable logic state. This may reduce the possibility of back and forth logic state change of the first control signal S₁ when the power supply voltage Vin has small fluctuations, which may be harmful to the ruggedness of the low drop-out voltage regulator 100. In this case, the first predetermined range Δᵢₙ (the effective range) of the power supply voltage Vin is controlled between ground potential and Vₜₕ₃. However, in some applications, it is desired that the effective range of the power supply voltage Vin starts from a potential higher than the ground potential. This may be achieved just by setting the fourth threshold voltage Vₜₕ₄ as the starting effective potential of the power supply voltage Vin. Therefore, in one exemplary embodiment, the fourth threshold voltage Vₜₕ₄ is lower than the third threshold voltage Vₜₕ₃. In this way, first predetermined range Δᵢₙ of the power supply voltage Vin is controlled between Vₜₕ₄ and Vₜₕ₃.

As illustrated in FIG. 3, in one embodiment, the first control circuit 105 may comprise: a first sensing circuit 201 having an input terminal configured to receive the power supply voltage Vin and an output terminal configured to provide a sensed voltage V_{S} related to the power supply voltage Vin (e.g. the sensed voltage V_{S} is a scaled down voltage of the power supply voltage Vin); and a first comparison circuit 202 having a first comparison input terminal configured to receive the sensed voltage V_{S}, a second comparison input terminal configured to receive a seventh threshold voltage Vₜₕ₇ related to the first threshold voltage Vₜₕ₁ (e.g. the seventh threshold voltage Vₜₕ₇ is a scaled down voltage of the first threshold voltage Vₜₕ₁), and a first comparator output terminal configured to provide the first control signal S₁ based on the sensed voltage V_{S} and the seventh threshold voltage Vₜₕ₇, wherein the first control signal S₁ is at the enable logic state when the sensed voltage V_{S} is lower than the seventh threshold voltage Vₜₕ₇, and wherein the first control signal S₁ is at the disable logic state when the sensed voltage V_{S} is higher than the seventh threshold voltage Vₜₕ₇.

In one embodiment, the seventh threshold voltage Vₜₕ₇ may comprise an eighth threshold voltage Vₜₕ₈ and a ninth threshold voltage Vₜₕ₉ respectively related to the third threshold voltage Vₜₕ₃ and the fourth threshold voltage Vₜₕ₄, wherein the ninth threshold voltage Vₜₕ₉ has a third predetermined hysteresis from the eighth threshold voltage Vₜₕ₈, and wherein the first control signal S₁ is at the enable logic state when the sensed voltage V_{S} is lower than the eighth threshold voltage Vₜₕ₈, and wherein the first control signal S₁ is at the disable logic state when the sensed voltage V_{S} is higher than the ninth threshold voltage Vₜₕ₉.

In one embodiment, the first sensing circuit 201 may comprise a first voltage divider comprising: a first resistive device 201₁ coupled between the input terminal and the output terminal of the first sensing circuit 201; and a second resistive device 201₂ coupled between the output terminal of the first sensing circuit 201 and ground. In one embodiment, the first resistive device 201₁ may comprise a high-voltage resistor. In other embodiments, the first resistive device 201₁ may comprise other high-voltage resistive devices, such as high-voltage JFET, high-voltage MOSFET, high-voltage BJT etc. In still other embodiments, the first resistive device 201₁ may comprise the combinations of a high voltage transistor and a resistor. For example, in the exemplary embodiment shown in FIG. 3, the first resistive device 201₁ comprises a high-voltage JFET and a resistor connected in series between the input terminal and the output terminal of the first sensing circuit 201. In one embodiment, the second resistive device 201₂ may comprise a resistor. In other embodiments, the second resistive device 201₂ may comprise other resistive devices such as JFET, MOSFET, BJT, etc. In still other embodiments, the second resistive device 201₂ may comprise the combinations of a high voltage transistor and a resistor.

In one embodiment, the first comparison circuit 202 may comprise a hysteresis comparator having the eighth threshold voltage Vₜₕ₈ and the ninth threshold voltage Vₜₕ₉.

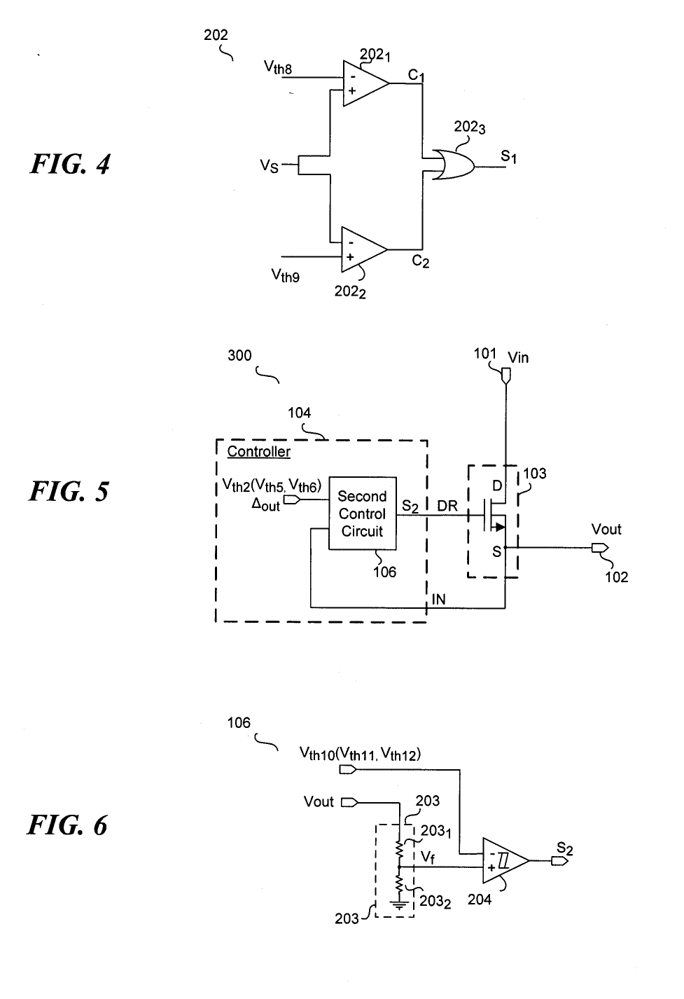

In other embodiment, as illustrated in FIG. 4, the first comparison circuit 202 may comprise a first comparator 202₁ having a first input terminal configured to receive the sensed voltage V_{S}, a second input terminal configured to receive the eighth threshold voltage Vₜₕ₈, and an output terminal configured to provide a first comparison signal C₁ based on the sensed voltage V_{S} and the eighth threshold voltage Vₜₕ₈, wherein the first comparison signal C₁ has an enable logic state and a disable logic state, and wherein the first comparison signal C₁ is at the enable logic state when the sensed voltage V_{S} is lower than the eighth threshold voltage Vₜₕ₈, and wherein the first comparison signal C₁ is at the disable logic state when the sensed voltage V_{S} is higher than the eighth threshold voltage Vₜₕ₈; a second comparator 202₂ having a first input terminal configured to receive the sensed voltage V_{S}, a second input terminal configured to receive the ninth threshold voltage Vₜₕ₉, and an output terminal configured to provide a second comparison signal C₂ based on the sensed voltage V_{S} and the ninth threshold voltage Vₜₕ₉, wherein the second comparison signal C₂ has an enable logic state and a disable logic state, and wherein the second comparison signal C₂ is at the enable logic state when the sensed voltage V_{S} is lower than the ninth threshold voltage Vₜₕ₉, and wherein the second comparison signal C₂ is at the disable logic state when the sensed voltage V_{S} is higher than the ninth threshold voltage Vₜₕ₉; and a first OR logic circuit 202₃ having a first input terminal configured to receive the first comparison signal C₁, a second input terminal configured to receive the second comparison signal C₂, and an output terminal configured to provide the first control signal S₁.

FIG. 5 illustrates a schematic diagram of a low drop-out voltage regulator 300 in accordance with another embodiment of the present invention. Components or structures in the low drop-out voltage regulator 300 with substantially the same functions as those of the low drop-out voltage regulator 100 are identified by the same reference labels as used in the low drop-out voltage regulator 100 for the sake of simplicity. As illustrated in FIG. 5, the input signal IN may comprise the output voltage Vout, and the predetermined range may comprise a second predetermined range Δₒᵤₜ.

In one embodiment, still referring to FIG. 5, the controller 104 may comprise a second control circuit 106 having a first input terminal configured to receive the output voltage Vout, a second input terminal configured to receive a second threshold voltage Vₜₕ₂, and an output terminal configured to provide a second control signal S₂ having an enable logic state and a disable logic state, wherein the second control signal S₂ is at the enable logic state when the output voltage Vout is lower than the second threshold voltage Vₜₕ₂, and wherein the second control signal S₂ is at the disable logic state when the output voltage Vout is higher than the second threshold voltage Vₜₕ₂, and wherein the second control signal S₂ may constitute the driving signal DR, and wherein the driving signal DR turns the pass device 103 ON when the second control signal S₂ is at the enable logic state, and wherein the driving signal DR turns the pass device OFF when the second control signal S₂ is at the disable logic state.

In this case, the second predetermined range Δhd out is substantially controlled around the second threshold voltage Vₜₕ₂.

In one embodiment, the controller 104 may further comprise a logic driving circuit such as a driver (not shown) configured to receive the second control signal S₂ and to convert the second control signal S₂ into the driving signal DR. The logic driving circuit in this case is usually provided to improve the driving capability of the driving signal DR.

In one embodiment, the second threshold voltage Vₜₕ₂ may comprise a fifth threshold voltage Vₜₕ₅ and a sixth threshold voltage Vₜₕ₆, wherein the sixth threshold voltage Vₜₕ₆ has a second predetermined hysteresis from the fifth threshold voltage Vₜₕ₅, and wherein the second control signal S₂ is at the enable logic state when the output voltage Vout is lower than the fifth threshold voltage V_{th5,} and wherein the second control signal S₂ is at the disable logic state when the output voltage Vout is higher than the sixth threshold voltage Vₜₕ₆.

In this case, the second predetermined range Δₒᵤₜ is substantially controlled between the fifth threshold voltage Vₜₕ₅ and a sixth threshold voltage Vₜₕ₆.

In one embodiment, as illustrated in FIG. 6, the second control circuit 106 may comprise: a second sensing circuit 203 having an input terminal configured to receive the regulated output voltage Vout and an output terminal configured to provide a feedback voltage V_{f} related to the regulated output voltage Vout (e.g. the feedback voltage V_{f} is a scaled down voltage of the output voltage Vout); and a second comparison circuit 204 having a third comparison input terminal configured to receive the feedback voltage V_{f}, a fourth comparison input terminal configured to receive a tenth threshold voltage Vₜₕ₁₀ related to the second threshold voltage Vₜₕ₂ (e.g. the tenth threshold voltage Vₜₕ₁₀ is a scaled down voltage of the second threshold voltage Vₜₕ₂), and a second comparison output terminal configured to provide the second control signal S₂ based on the feedback voltage V_{f} and the tenth threshold voltage Vₜₕ₁₀, wherein the second control signal S₂ is at the enable logic state when the feedback voltage V_{f} is lower than the tenth threshold voltage Vₜₕ₁₀, and wherein the second control signal S₂ is at the disable logic state when the feedback voltage V_{f} is higher than the tenth threshold voltage Vₜₕ₁₀.

In one embodiment, the tenth threshold voltage Vₜₕ₁₀ may comprise an eleventh threshold voltage Vₜₕ₁₁ and a twelfth threshold voltage Vₜₕ₁₂ respectively related to the fifth threshold voltage Vₜₕ₅ and the sixth threshold voltage Vₜₕ₆, wherein the twelfth threshold voltage Vₜₕ₁₂ has a fourth predetermined hysteresis from the eleventh threshold voltage Vₜₕ₁₁, and wherein the second control signal S₂ is at the enable logic state when the feedback voltage V_{f} is lower than the eleventh threshold voltage Vₜₕ₁₁, and wherein the second control signal S₂ is at the disable logic state when the feedback voltage V_{f} is higher than the twelfth threshold voltage Vₜₕ₁₂.

In one embodiment, the second sensing circuit 203 may comprise a second voltage divider comprising: a third resistive device 203₁ coupled between the input terminal and the output terminal of the second sensing circuit 203; and a fourth resistive device 203₂ coupled between the output terminal of the second sensing circuit 203 and ground. In one embodiment, the third resistive device 203₁ may comprise a first resistor; the fourth resistive device 203₂ may comprise a second resistor. In other embodiments, the third resistive device 203₁ may comprise other resistive devices, such as JFET, MOSFET, and BJT etc. In other embodiments, the fourth resistive device 203₂ may also comprise other resistive devices such as JFET, MOSFET, BJT, etc.

In one embodiment, the second comparison circuit 204 may comprise a hysteresis comparator having the eleventh threshold voltage Vₜₕ₁₁ and the twelfth threshold voltage Vₜₕ₁₂.

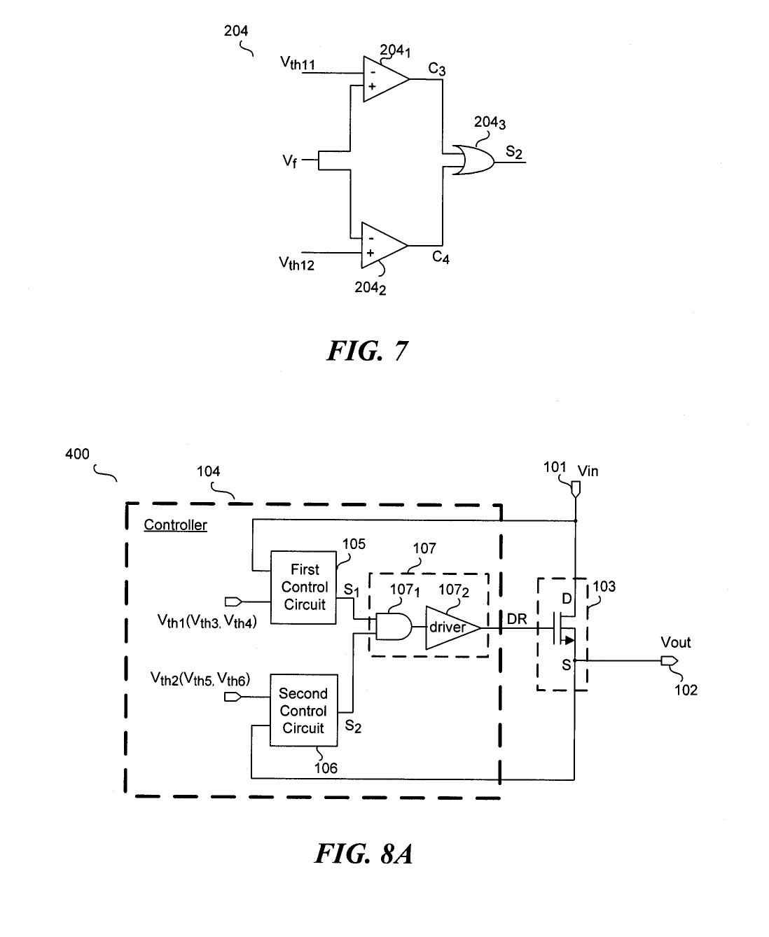

In other embodiment, as illustrated in FIG. 7, the second comparison circuit 204 may comprise a third comparator 204₁ having a first input terminal configured to receive the feedback voltage V_{f}, a second input terminal configured to receive the eleventh threshold voltage Vₜₕ₁₁, and an output terminal configured to provide a third comparison signal C₃ based on the feedback voltage V_{f} and the eleventh threshold voltage Vₜₕ₁₁, wherein the third comparison signal C₃ has an enable logic state and a disable logic state, and wherein the third comparison signal C₃ is at the enable logic state when the feedback voltage V_{f} is lower than the eleventh threshold voltage Vₜₕ₁₁, and wherein the third comparison signal C₃ is at the disable logic state when the feedback voltage V_{f} is higher than the eleventh threshold voltage Vₜₕ₁₁; a fourth comparator 204₂ having a first input terminal configured to receive the feedback voltage V_{f}, a second input terminal configured to receive the twelfth threshold voltage Vₜₕ₁₂, and an output terminal configured to provide a fourth comparison signal C₄ based on the feedback voltage V_{f} and the twelfth threshold voltage Vₜₕ₁₂, wherein the fourth comparison signal C₄ has an enable logic state and a disable logic state, and wherein the fourth comparison signal C₄ is at the enable logic state when the feedback voltage V_{f} is lower than the twelfth threshold voltage Vₜₕ₁₂, and wherein the fourth comparison signal C₄ is at the disable logic state when the feedback voltage V_{f} is higher than the twelfth threshold voltage Vₜₕ₁₂; and a second OR logic circuit 204₃ having a first input terminal configured to receive the third comparison signal C₃, a second input terminal configured to receive the fourth comparison signal C₄, and an output terminal configured to provide the second control signal S₂.

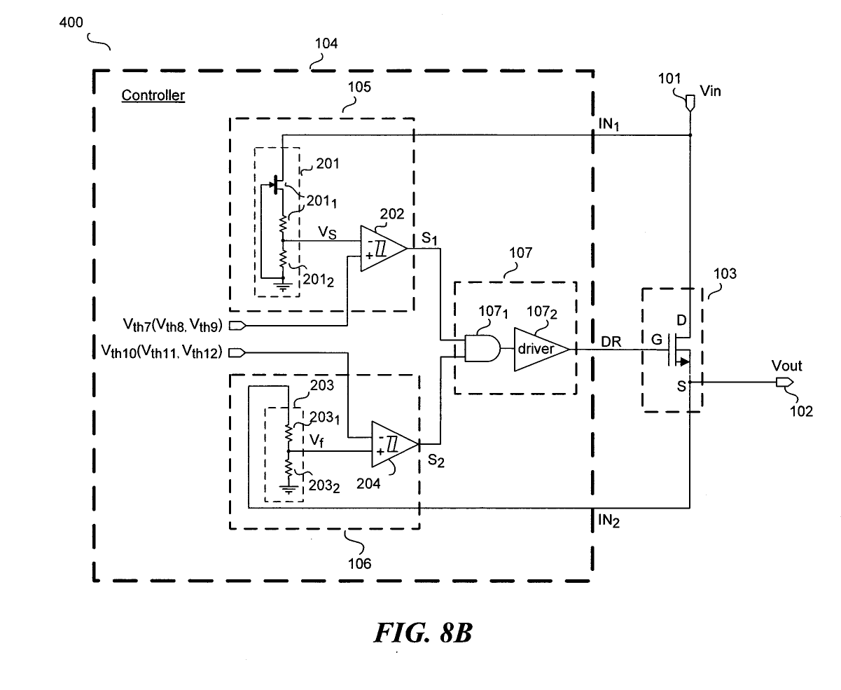

FIG. 8A illustrates a schematic diagram of a low drop-out voltage regulator 400 in accordance with another embodiment of the present invention. Components or structures in the low drop-out voltage regulator 300 with substantially the same functions as those of the low drop-out voltage regulators 100, 200 and 300 are identified by the same reference labels as used in the low drop-out voltage regulators 100, 200 and 300 for the sake of simplicity. As illustrated in FIG. 8A, the input terminal IN may comprise a first input terminal IN₁ and a second input terminal IN₂, the input signal may comprise the power supply voltage Vin and the output voltage Vout, and the predetermined range may comprise the first predetermined range Δᵢₙ and the second predetermined range Δₒᵤₜ, wherein the first input terminal IN₁ is configured to receive the power supply voltage Vin, and wherein the second input terminal IN₂ is configured to receive the output voltage Vout, and wherein the driving signal DR turns the pass device 103 ON when the power supply voltage Vin is within the first predetermined range Δᵢₙ and the output voltage Vout is within the second predetermined range Δₒᵤₜ; and wherein the driving signal DR turns the pass device 103 OFF when the power supply voltage Vin is without the first predetermined range Δᵢₙ and/or the output voltage Vout is without the second predetermined range Δₒᵤₜ.

In one embodiment, still referring to FIG. 8A, the controller 104 may comprise the first control circuit 105 as described with reference to FIG. 2; the second control circuit 106 as described with reference to FIG. 5; and a logic circuit 107 having a first input terminal configured to receive the first control signal S₁, a second input terminal configured to receive the second control signal S₂, and an output terminal configured to provide the driving signal DR to the control terminal of the pass device 103, wherein the driving signal DR is at the enable logic state when the first control signal S₁ is at the enable logic state and the second control signal S₂ is also at the enable logic state, and wherein the driving signal DR is at the disable logic state when the first control signal S₁ is at the disable logic state or the second control signal S₂ is at the disable logic state; and wherein the driving signal DR turns the pass device 103 on when the driving signal DR is at the enable logic state, and wherein the driving signal DR turns the pass device 103 off when the driving signal DR is at the disable logic state.

In one embodiment, the logic circuit 107 may comprise an AND logic circuit. In other embodiment, the logic circuit 107 may comprise an AND gate 107₁ configured to receive the first control signal S1 and the second control signal S2, and to provide an “AND signal” of the first control signal S1 and the second control signal S2; and a driver 107₂ configured to receive the “AND signal” and to provide the driving signal DR. In still other embodiments, the logic circuit 107 may comprise other logic components.

In one embodiment, as illustrated in FIG. 8B, the controller 104 may comprise the first control circuit 105 as described with reference to FIGS. 3˜4; the second control circuit 106 as described with reference to FIGS. 4˜7; and the logic circuit 107 as described above.

In accordance with the various embodiments described with reference to FIG. 1 to FIG. 8B, the low drop-out voltage regulators 100, 200, 300 and 400 convert the power supply voltage Vin to the output voltage Vout. The power supply voltage Vin may comprise a DC voltage or an AC voltage, and may vary largely under different conditions. In certain applications, the power supply voltage Vin may rise as high as several hundreds volts, such as 400V. The first predetermined range Δᵢₙ and the second predetermined range Δₒᵤₜ may be appropriately chosen according to practical application requirements, and/or may be programmable or user-definable. Accordingly, the first threshold voltage Vₜₕ₁ and the second threshold voltage Vₜₕ₂ may be predetermined respectively corresponding to the first predetermined range Δᵢₙ and the second predetermined range Δₒᵤₜ according to practical application needs. For example, the first threshold voltage Vₜₕ₁ may be several volts to several tens volts, such as 20V; the second threshold voltage Vₜₕ₂ may be several volts to several tens volts, such as 10V. Similarly, the third threshold voltage Vₜₕ₃, the fourth threshold voltage V_{th4,} the fifth threshold voltage Vₜₕ₅ and the sixth threshold voltage Vₜₕ₆ may also be predetermined according to practical application requirements.

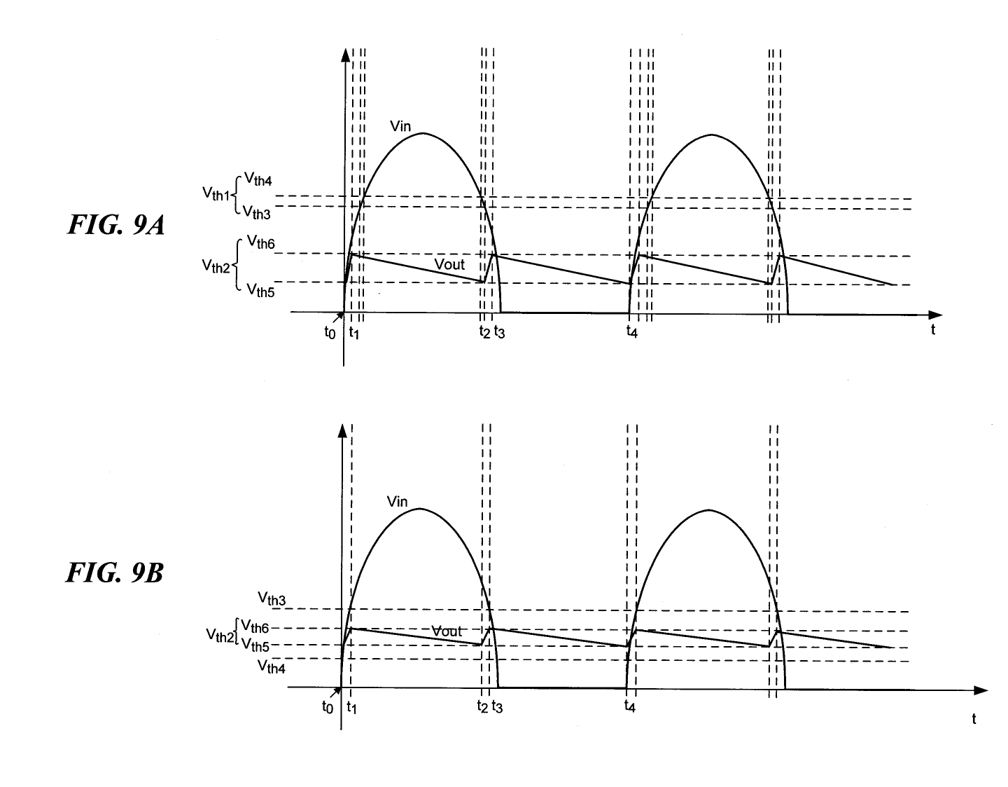

For better understanding of the various embodiments of the present invention. Operation principles of the low drop-out voltage regulator 400 will be explained herein as an example with reference to FIGS. 9A and 9B.

FIG. 9A illustrates schematically an operating waveform diagram of the low drop-out voltage regulator 400 in accordance with an embodiment of the present invention. In this exemplary embodiment, the fourth threshold voltage Vₜₕ₄ is set higher than the third threshold Vₜₕ₃ for alleviating the influence of small fluctuations of the power supply voltage Vin to the regulator circuit 400. As shown in FIG. 9A, the power supply voltage Vin comprises a rectified AC voltage.

From time t₀ to t₁, the power supply voltage Vin is lower than the third threshold voltage Vₜₕ₃, and the output voltage Vout is lower than the fifth threshold voltage Vₜₕ₅, thus, the first control signal S₁ and the second control signal S₂ are respectively at their enable logic states, resulting in the driving signal DR being at the enable logic state and turning the pass device 103 ON such that the power supply voltage Vin charges the output voltage Vout. At time t₁, the output voltage Vout is charged to exceed the sixth threshold voltage Vₜₕ₆, the second control signal S₂ changes to the disable logic state, resulting in the driving signal DR changing to the disable logic state and turning the pass device 103 OFF such that the output voltage Vout starts to be discharged.

From time t₁ to t₂, either the first control signal S₁ is at the disable logic state or the control signal S₂ is at the disable logic state, thus, the driving signal DR is at the disable logic state, keeping the pass device 103 OFF. At time t₂, the power supply voltage Vin falls below the third threshold voltage Vₜₕ₃ again, and the output voltage Vout falls below the fifth threshold voltage Vₜₕ₅, thus, both the first control signal S₁ and the second control signal S₂ change to their enable logic states, resulting in the driving signal DR changing to the enable logic state and turning the pass device 103 ON.

From time t₂ to t₃, the pass device 103 remains ON, the power supply voltage Vin charges the output voltage Vout until at time t₃, the output voltage Vout exceeds the sixth threshold voltage Vₜₕ₆, the second control signal S₂ changes to the disable logic state, resulting in the driving signal DR changing to the disable logic state. Thus, at time t₃, the pass device 103 is turned OFF again, the output voltage Vout starts to be discharged.

From time t₃ to t₄, the driving signal DR keeps at the disable logic state, the pass device 103 remains OFF until at time t₄, the output voltage Vout is discharged below the fifth threshold voltage Vₜₕ₅. In the meanwhile, at time t₄, the power supply voltage Vin is lower than the third threshold voltage Vₜₕ₃, thus, the driving signal DR changes to the enable logic state again, turning the pass device 103 ON, the power supply voltage Vin starts to charge the output voltage Vout again. In the following, the low drop-out voltage regulator 400 repeats the above described operations periodically.

FIG. 9B illustrates schematically an operating waveform diagram of the low drop-out voltage regulator 400 in accordance with another embodiment of the present invention. As illustrated in FIG. 9B, in this exemplary embodiment, the fourth threshold voltage Vₜₕ₄ is set to be lower than the third threshold voltage Vₜₕ₃. The operation processes of the low drop-out voltage regulator 400 of this embodiment are similar as those of the embodiment described with reference to FIG. 9A. As can be seen from FIG. 9B, in this case, the pass device 103 is turned ON thereby charging the output voltage Vout only when the power supply voltage Vin is higher than the fourth threshold voltage Vₜₕ₄ and lower than the third threshold voltage Vₜₕ₃, and the output voltage Vout is higher than the fifth threshold voltage Vₜₕ₅ and lower than the sixth threshold voltage Vₜₕ₆.

Based on the operation principles of the low drop-out voltage regulator 400 described above with reference to FIGS. 9A and 9B, it is easy for those skilled in the art to understand the operation principles of the low drop-out voltage regulators 100, 200 and 300, which will not be addressed in detail herein.

For the low drop-out voltage regulator 100 illustrated in the example of FIG. 1, the pass device 103 is turned ON thereby charging the output voltage Vout only when the input signal IN is within the predetermined range. In this way, users may be able to flexibly control the operation of the low drop-out voltage regulator according to practical application needs via appropriately providing the input signal IN and appropriately defining the predetermined range. The low drop-out voltage regulator 100 operates only when the input signal IN is within the predetermined range which represents the desired effective operation range, thus, loss in power may be reduced thereby improving power conversion efficiency. In addition, since power consumption can be reduced and the effective operation range of the low drop-out voltage regulator is controllable, the low drop-out voltage regulator 100 may be directly powered by a high-voltage power bus while reducing the risk of causing thermal problems.

In the exemplary embodiments described with reference to FIG. 2 to FIG. 4, the input signal IN comprises the power supply voltage Vin. In this situation, it is feasible to control the operation of the low drop-out voltage regulator via monitoring the power supply voltage Vin. For example, in the voltage regulator 200, the pass device 103 may be turned ON thereby permitting the power supply voltage Vin to charge the output voltage Vout only when the power supply voltage Vin is within the first predetermined range Δᵢₙ. In one embodiment, the first predetermined range Δᵢₙ may be controlled between ground potential and the first threshold voltage Vₜₕ₁. In one embodiment, the first predetermined range Δᵢₙ may be controlled between the fourth threshold voltage Vₜₕ₄ and the third threshold voltage Vₜₕ₃. Therefore, power consumption of the low drop-out voltage regulator 200 is reduced while the power conversion efficiency is improved. Furthermore, the low drop-out voltage regulator 200 could be directly connected to an AC power supply voltage with alleviated thermal concerns.

In the exemplary embodiments described with reference to FIG. 5 to FIG. 7, the input signal IN comprises the output voltage Vout. In accordance with one embodiment as illustrated in FIG. 5, the voltage regulator 300 may be able to regulate the output voltage Vout within the second predetermined range Δₒᵤₜ. In one embodiment, the second predetermined range Δₒᵤₜ may be controlled around the second threshold voltage Vₜₕ₂. In one embodiment, the second predetermined range Δₒᵤₜ may be controlled between the fifth threshold voltage Vₜₕ₅ and the sixth threshold voltage Vₜₕ₆. In one embodiment, the second hysteresis between the fifth threshold voltage Vₜₕ₅ and the sixth threshold voltage Vₜₕ₆ could be set to be small enough to ensure the stability of the output voltage Vout. Generally, the second predetermined range Δₒᵤₜ (or the second threshold Vₜₕ₂, or the fifth threshold voltage Vₜₕ₅ and the sixth threshold voltage Vₜₕ₆) may be appropriately chosen according to application requirement while ensuring the operation safety of the voltage regulator. For example, since the pass device 103 is turned ON to allow the power supply voltage Vin to charge the output voltage Vout only when the output voltage Vout is within the second predetermined range Δₒᵤₜ, it may be possible to indirectly control the power supply voltage Vin to supply the voltage regulator only within an acceptable safe range via appropriately setting the second predetermined range Δₒᵤₜ. In addition, the regulators according to the exemplary embodiments described with reference to FIG. 5 to FIG. 7 also feature the advantages of improved power conversion efficiency and directly drawing power from an AC power supply voltage with alleviated thermal concerns.

In the exemplary embodiments described with reference to FIGS. 8A and 8B, the input signal IN comprises the power supply voltage Vin and the output voltage Vout. The pass device 103 is turned ON (i.e. the power supply voltage Vin is allowed to charge the output voltage Vout) only when the power supply voltage Vin is within the first predetermined range Δᵢₙ and the output voltage Vout is within the second predetermined range Δₒᵤₜ. Thus, the low drop-out voltage regulators described with reference to FIGS. 8A and 8B may have the combined advantages of the low drop-out voltage regulators 100, 200 and 300 as stated above.

The low drop-out voltage regulators in accordance with various embodiments described with reference to FIGS. 1˜9B convert the power supply voltage Vin to the output voltage Vout based on controlling the pass device 103 ON and OFF through the controller 104. As addressed previously, the output voltage Vout may be regulated within a second predetermined range. In one embodiment, the second predetermined range Δₒᵤₜ is substantially controlled around the second threshold voltage Vₜₕ₂. In one embodiment, the predetermined range Δₒᵤₜ is substantially controlled between a fifth threshold voltage Vₜₕ₅ and a sixth threshold voltage Vₜₕ₆, wherein the sixth threshold voltage Vₜₕ₆ has a second predetermined hysteresis from the fifth threshold voltage Vₜₕ₅. In these situations, the output voltage Vout may have some ripples. In some applications, the output voltage Vout may be directly applied for driving a load. However, in other applications, it is desired that the output voltage Vout be further smoothed.

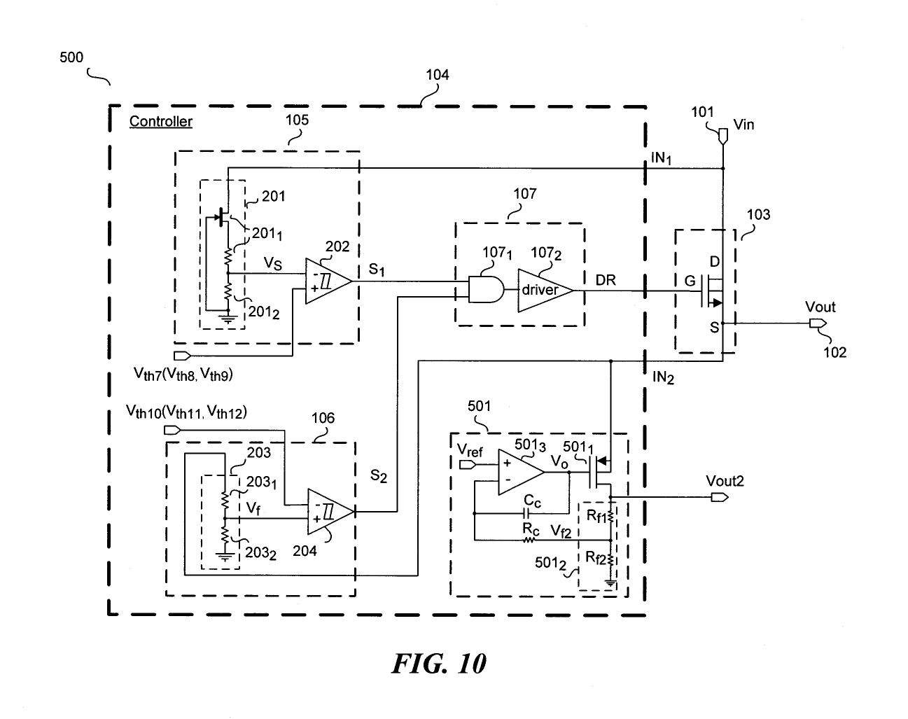

FIG. 10 illustrates schematically a low drop-out voltage regulator 500 in accordance with another embodiment of the present invention. Components or structures in the low drop-out voltage regulator 500 with substantially the same functions as those of the low drop-out voltage regulators 100, 200, 300, and 400 are identified by the same reference labels as used in the low drop-out voltage regulators 100, 200, 300, and 400 for the sake of simplicity. As shown in FIG. 10, the low drop-out voltage regulator 500 may further comprise a linear regulator 501 for regulating the output voltage Vout into a second output voltage Vout2 which is smoother than the output voltage Vout (i.e. the second output voltage Vout2 has smaller ripples than the output voltage Vout).

In one embodiment, the linear regulator 501 may comprise a transistor 501₁ having a first transistor terminal, a second transistor terminal and a transistor control terminal wherein the first transistor terminal is configured to receive the output voltage Vout, the second transistor terminal is configured to generate the second output voltage Vout2; a feedback circuit 501₂ having a feedback input terminal configured to receive the second output voltage Vout2, and a feedback output terminal configured to provide a regulator feedback signal V_{f2} related to the second output voltage Vout2 (e.g. the regulator feedback signal V_{f2} is a scaled down voltage of the second output voltage Vout2); and an amplifier 501₃ having a first amplifier input terminal configured to receive a reference signal V_{ref}, a second amplifier input terminal configured to receive the regulator feedback signal V_{f2}, and an amplifier output terminal configured to provide a transistor control signal Vₒ to the transistor control terminal of the transistor 501₁, wherein the transistor control signal Vₒ represents a difference between the second output voltage Vout2 and the reference signal V_{ref}, and wherein the transistor control signal Vₒ drives the transistor 501₁ to generate the second output voltage Vout2 at the second transistor terminal. In such a configuration, the linear regulator 501 is able to regulate the second output voltage Vout2 at a desired value through negative feedback regulation. The reference signal V_{ref} may be selected depending on the desired value of the second output voltage Vout2.

In one embodiment, the linear regulator 501 may further comprise a compensation circuit comprising a compensation capacitor C_{C} coupled between the second amplifier input terminal and the amplifier output terminal; and a compensation resistor R_{C} coupled between the second amplifier input terminal and the feedback output terminal. The compensation capacitor C_{C} and the compensation resistor R_{C} may help to improve the feedback regulation stability of the linear regulator 501. In other embodiments, other compensation circuits may be used.

In one embodiment, the feedback circuit 501₂ may comprise a third voltage divider comprising: a fifth resistive device R_{f1} coupled between the input terminal and the output terminal of the feedback circuit 501₂; and a sixth resistive device R_{f2} coupled between the output terminal of the feedback circuit 501₂ and ground. In one embodiment, the fifth resistive device R_{f1} may comprise a third resistor; the sixth resistive device R_{f2} may comprise a fourth resistor. In other embodiments, the fifth resistive device R_{f1} may comprise other resistive devices, such as JFET, MOSFET, and BJT etc. In other embodiments, the sixth resistive device R_{f2} may also comprise other resistive devices such as JFET, MOSFET, BJT, etc.

In the exemplary embodiment shown in FIG. 10, the linear regulator 501 is integrated into the controller 104. In other embodiments, the linear regulator 501 may not be integrated into the controller 104. For example, the linear regulator 501 may be by chosen and added by user according to practical application needs.

For all the low drop-out voltage regulators 100, 200, 300, 400, and 500 described in this disclosure, the pass device 103 and the controller 104 may be integrated together and formed on a same die or be separated and formed on different dies.

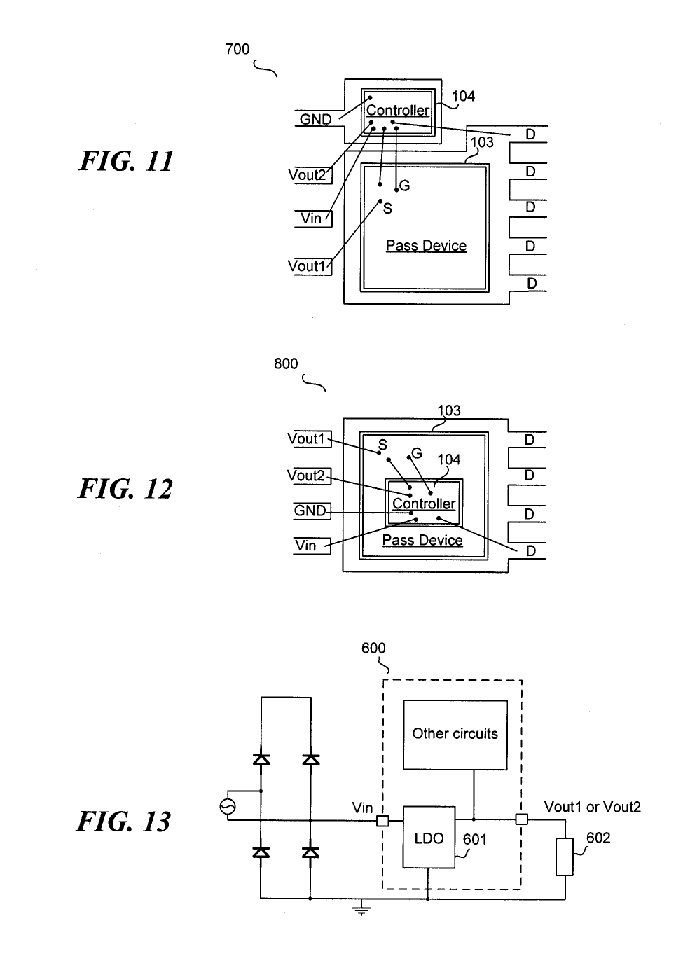

FIG. 11 illustrates a top plane view of a package 700 in which the pass device 103 and the controller 104 are encapsulated in an encapsulant in accordance with an embodiment of the present invention. In the illustrated embodiment, the pass device 103 is built on one bare chip. The controller 104 is built on another separate chip. The pass device 103 and the controller 104 are arranged on the same plan. This dual-chip module package can reduce the size of the low drop-out regulator system.

FIG. 12 illustrates a top plane view of a package 800 in which the pass device 103 and the controller 104 are encapsulated in an encapsulant in accordance with another embodiment of the present invention. In this illustrated embodiment, the pass device 103 and the controller 104 are also built on two separate chips. The controller 104 is stacked on the pass device 103 for further reducing the size of the low drop-out regulator system.

In other embodiments, the pass device 103 and the controller 104 may be packaged in other arrangements.

The low drop-out voltage regulators in accordance with various embodiments of the present invention may be employed alone or be integrated with other integrated circuits to provide power for various electronic devices.

FIG. 13 illustrates schematically an electronic circuit 600 comprising a low drop-out voltage regulator 601 configured to convert a power supply voltage Vin to an output voltage Vout; and a load 602 configured to receive the output voltage Vout; wherein the low drop-out voltage regulator 601 may comprise one of the low drop-out voltage regulators in accordance with various embodiments of the present invention, such as the low drop-out voltage regulator 100 or 200 or 300 or 400 or 500. The electronic circuit 600 may further comprise other circuits that could be powered by the low drop-out voltage regulator 601. The power supply voltage Vin may comprise a rectified AC voltage. The load 602 may comprise any electronic devices such as communication devices, portable devices including laptop computers, mobile telephones, and personal digital assistants etc.

The advantages of the various embodiments of the present invention are not confined to those described above. These and other advantages of the various embodiments of the present invention will become more apparent upon reading the whole detailed descriptions and studying the various figures of the drawings.

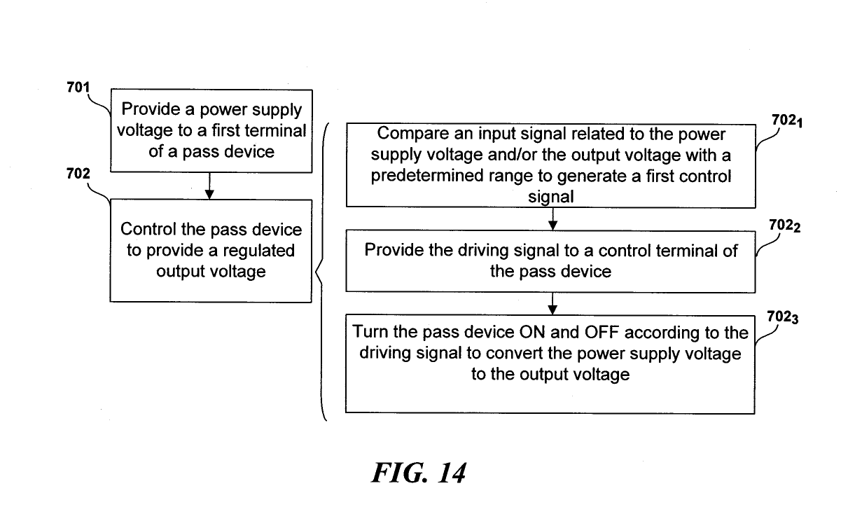

FIG. 14 shows a flow chart illustrating a method for converting a power supply voltage to a regulated output voltage in accordance with an embodiment of the present invention. The method comprises: providing the power supply voltage to a first terminal of a pass device at step 701, wherein the pass device further comprises a second terminal and a control terminal; and controlling the pass device to provide the regulated output voltage at the second terminal at step 702; wherein controlling the pass device at the step 702 may comprise: step 702₁, comparing an input signal related to the power supply voltage and/or the output voltage with a predetermined range to generate a driving signal having an enable logic state and a disable logic state, wherein the driving signal is at the enable logic state when the input signal is within the predetermined range, and wherein the driving signal is at the disable logic state when the input signal is without the predetermined range; step 702₂, providing the driving signal to the control terminal of the pass device; and step 702₃, turning the pass device ON when the driving signal is at the enable logic state, and turning the pass device OFF when the driving signal is at the disable logic state.

In one embodiment, the input signal may comprise the power supply voltage, and the predetermined range may comprise a first predetermined range.

In one embodiment, the input signal may comprise the output voltage, and the predetermined range may comprise a second predetermined range.

In one embodiment, the input signal may comprise the power supply voltage and the output voltage, the predetermined range may comprise the first predetermined range and the second predetermined range, wherein comparing the input signal with the predetermined range at the step 702₁ may comprise: comparing the power supply voltage with the first predetermined range to generate a first control signal having an enable logic state and a disable logic state, wherein the first control signal is at the enable logic state when the power supply voltage is within the first predetermined range, and wherein the first control signal is at the disable logic state when the power supply voltage is without the first predetermined range; comparing the output voltage with the second predetermined range to generate a second control signal having an enable logic state and a disable logic state, wherein the second control signal is at the enable logic state when the regulated output voltage is within the second predetermined range, and wherein the second control signal is at the disable logic state when the regulated output voltage is without the second predetermined range; and generating the driving signal based on the first control signal and the second control signal, wherein the driving signal is at the enable logic state when the first control signal is at the enable logic state and the second control signal is also at the enable logic state, and wherein the driving signal is at the disable logic state when the first control signal is at the disable logic state and/or the second control signal is at the disable logic state.

In one embodiment, comparing the power supply voltage with the first predetermined range may comprise: comparing the power supply voltage with a first threshold voltage to generate the first control signal, wherein the first control signal is at the enable logic state when the power supply voltage is lower than the first threshold voltage, and wherein the first control signal is at the disable logic state when the power supply voltage is higher than the first threshold voltage.

In one embodiment, the first threshold voltage may comprise a third threshold voltage and a fourth threshold voltage, wherein the fourth threshold voltage has a first predetermined hysteresis from the third threshold voltage, and wherein the first control signal is at the enable logic state when the power supply voltage is lower than the third threshold voltage, and wherein the first control signal is at the disable logic state when the power supply voltage is higher than the fourth threshold voltage.

In one embodiment, comparing the output voltage with the second predetermined range may comprise: comparing the output voltage with a second threshold voltage to generate the second control signal, wherein the second control signal is at the enable logic state when the regulated output voltage is lower than the second threshold voltage, and wherein the second control signal is at the disable logic state when the regulated output voltage is higher than the second threshold voltage.

In one embodiment, the second threshold voltage may comprise a fifth threshold voltage and a sixth threshold voltage, wherein the sixth threshold voltage has a second predetermined hysteresis from the fifth threshold voltage, and wherein the second control signal is at the enable logic state when the output voltage is lower than the fifth threshold voltage, and wherein the second control signal is at the disable logic state when the output voltage is higher than the sixth threshold voltage.

In one embodiment, comparing the power supply voltage with the first threshold voltage may comprise: monitoring the power supply voltage to generate a sensed voltage related to the power supply voltage; and comparing the sensed voltage with a seventh threshold voltage related to the first threshold voltage to generate the first control signal, wherein the first control signal is at the enable logic state when the sensed voltage is lower than the seventh threshold voltage, and wherein the first control signal is at the disable logic state when the sensed voltage is higher than the seventh threshold voltage. In one embodiment, the seventh threshold voltage may comprise an eighth threshold voltage and a ninth threshold voltage, and wherein the ninth threshold voltage has a predetermined hysteresis from the eighth threshold voltage, and wherein the first control signal is at the enable logic state when the sensed voltage is lower than the eighth threshold voltage, and wherein the first control signal is at the disable logic state when the sensed voltage is higher than the ninth threshold voltage.

In one embodiment, comparing the output voltage with the second threshold voltage may comprise: monitoring the output voltage to generate a feedback voltage related to the output voltage; and comparing the feedback voltage with a tenth threshold voltage related to the second threshold voltage to generate the second control signal, wherein the second control signal is at the enable logic state when the feedback voltage is lower than the tenth threshold voltage, and wherein the second control signal is at the disable logic state when the feedback voltage is higher than the tenth threshold voltage. In one embodiment, the tenth threshold voltage may comprise an eleventh threshold voltage and a twelfth threshold voltage, and wherein the twelfth threshold voltage has a predetermined hysteresis from the eleventh threshold voltage, and wherein the second control signal is at the enable logic state when the feedback voltage is lower than the eleventh threshold voltage, and wherein the second control signal is at the disable logic state when the feedback voltage is higher than the twelfth threshold voltage.

From the foregoing, it will be appreciated that specific embodiments of the present invention have been described herein for purposes of illustration, but that various modifications may be made without deviating from the technology. Many of the elements of one embodiment may be combined with other embodiments in addition to or in lieu of the elements of the other embodiments. Accordingly, the present invention is not limited except as by the appended claims.

I/We claim:

1. A low drop-out voltage regulator, comprising:
an input terminal configured to receive a power supply voltage;
an output terminal configured to provide an output voltage;
a pass device having a first terminal, a second terminal and a control terminal, wherein the first terminal is coupled to the input terminal, and wherein the second terminal is coupled to the output terminal; and
a controller comprising an input terminal configured to receive an input signal, and an output terminal configured to provide a driving signal to the control terminal of the pass device based on the input signal, wherein the driving signal turns the pass device ON when the input signal is within a predetermined range; and wherein the driving signal turns the pass device OFF when the input signal is without the predetermined range.

2. The low drop-out voltage regulator of claim 1, wherein the pass device comprises a high-voltage semiconductor device controllable to be turned ON or OFF in response to a control signal applied at the control terminal.

3. The low drop-out voltage regulator of claim 1, wherein the input signal comprises the power supply voltage, and wherein the predetermined range comprises a first predetermined range.

4. The low drop-out voltage regulator of claim 1, wherein the controller comprises:
a first control circuit having a first input terminal configured to receive the power supply voltage, a second input terminal configured to receive a first threshold voltage, and an output terminal configured to provide a first control signal having an enable logic state and a disable logic state, wherein the first control signal is at the enable logic state when the power supply voltage is lower than the first threshold voltage, and wherein the first control signal is at the disable logic state when the power supply voltage is higher than the first threshold voltage; and wherein
the driving signal is generated based on the first control signal, and wherein the driving signal turns the pass device ON when the first control signal is at the enable logic state, and wherein the driving signal turns the pass device OFF when the first control signal is at the disable logic state.

5. The low drop-out voltage regulator of claim 4, wherein the first threshold voltage comprises a third threshold voltage and a fourth threshold voltage, wherein the fourth threshold voltage has a first predetermined hysteresis from the third threshold voltage, and wherein the first control signal is at the enable logic state when the power supply voltage is lower than the third threshold voltage, and wherein the first control signal is at the disable logic state when the power supply voltage is higher than the fourth threshold voltage.

6. The low drop-out voltage regulator of claim 4, wherein the first control circuit comprises:
a first sensing circuit having an input terminal configured to receive the power supply voltage and an output terminal configured to provide a sensed voltage related to the power supply voltage; and
a first comparison circuit having a first comparison input terminal configured to receive the sensed voltage, a second comparison input terminal configured to receive a seventh threshold voltage related to the first threshold voltage, and a first comparator output terminal configured to provide the first control signal based on the sensed voltage and the seventh threshold voltage, wherein the first control signal is at the enable logic state when the sensed voltage is lower than the seventh threshold voltage, and wherein the first control signal is at the disable logic state when the sensed voltage is higher than the seventh threshold voltage.

7. The low drop-out voltage regulator of claim 6, wherein the seventh threshold voltage comprises an eighth threshold voltage and a ninth threshold voltage, wherein the ninth threshold voltage has a third predetermined hysteresis from the eighth threshold voltage, and wherein the first control signal is at the enable logic state when the sensed voltage is lower than the eighth threshold voltage, and wherein the first control signal is at the disable logic state when the sensed voltage is higher than the ninth threshold voltage.

8. The low drop-out voltage regulator of claim 1, wherein the input signal comprises the output voltage, and wherein the predetermined range comprises a second predetermined range.

9. The low drop-out voltage regulator of claim 1, wherein the controller comprises:
a second control circuit having a first input terminal configured to receive the output voltage, a second input terminal configured to receive a second threshold voltage, and an output terminal configured to provide a second control signal having an enable logic state and a disable logic state, wherein the second control signal is at the enable logic state when the output voltage is lower than the second threshold voltage, and wherein the second control signal is at the disable logic state when the output voltage is higher than the second threshold voltage; and wherein
the driving signal is generated based on the second control signal, and wherein the driving signal turns the pass device ON when the second control signal is at the enable logic state, and wherein the driving signal turns the pass device OFF when the second control signal is at the disable logic state.

10. The low drop-out voltage regulator of claim 9, wherein the second threshold voltage comprises a fifth threshold voltage and a sixth threshold voltage, wherein the sixth threshold voltage has a second predetermined hysteresis from the fifth threshold voltage, and wherein the second control signal is at the enable logic state when the output voltage is lower than the fifth threshold voltage, and wherein the second control signal is at the disable logic state when the output voltage is higher than the sixth threshold voltage.

11. The low drop-out voltage regulator of claim 9, wherein the second control circuit comprises:
a second sensing circuit having an input terminal configured to receive the regulated output voltage and an output terminal configured to provide a feedback voltage related to the regulated output voltage; and
a second comparison circuit having a third comparison input terminal configured to receive the feedback voltage, a fourth comparison input terminal configured to receive a tenth threshold voltage related to the second threshold voltage, and a second comparison output terminal configured to provide the second control signal based on the feedback voltage and the tenth threshold voltage, wherein the second control signal is at the enable logic state when the feedback voltage is lower than the tenth threshold voltage, and wherein the second control signal is at the disable logic state when the feedback voltage is higher than the tenth threshold voltage.

12. The low drop-out voltage regulator of claim 11, wherein the tenth threshold voltage comprises an eleventh threshold voltage and a twelfth threshold voltage, wherein the twelfth threshold voltage has a fourth predetermined hysteresis from the eleventh threshold voltage, and wherein the second control signal is at the enable logic state when the feedback voltage is lower than the eleventh threshold voltage, and wherein the second control signal is at the disable logic state when the feedback voltage is higher than the twelfth threshold voltage.

13. The low drop-out voltage regulator of claim 1, wherein
the input terminal comprises a first input terminal and a second input terminal, and wherein
the input signal comprises the power supply voltage and the output voltage, and wherein
the predetermined range comprises a first predetermined range and a second predetermined range, and wherein
the first input terminal is configured to receive the power supply voltage, and wherein
the second input terminal is configured to receive the output voltage, and wherein
the driving signal turns the pass device ON when the power supply voltage is within the first predetermined range and the output voltage is within the second predetermined range, and wherein the driving signal turns the pass device OFF when the power supply voltage is without the first predetermined range and/or the output voltage is without the second predetermined range.

14. The low drop-out voltage regulator of claim 1, wherein the controller comprises:
a first control circuit having a first input terminal configured to receive the power supply voltage, a second input terminal configured to receive a first threshold voltage, and an output terminal configured to provide a first control signal having an enable logic state and a disable logic state, wherein the first control signal is at the enable logic state when the power supply voltage is lower than the first threshold voltage, and wherein the first control signal is at the disable logic state when the power supply voltage is higher than the first threshold voltage;
a second control circuit having a first input terminal configured to receive the output voltage, a second input terminal configured to receive a second threshold voltage, and an output terminal configured to provide a second control signal having an enable logic state and a disable logic state, wherein the second control signal is at the enable logic state when the output voltage is lower than the second threshold voltage, and wherein the second control signal is at the disable logic state when the output voltage is higher than the second threshold voltage; and
a logic circuit having a first input terminal configured to receive the first control signal, a second input terminal configured to receive the second control signal, and an output terminal configured to provide the driving signal to the control terminal of the pass device, wherein the driving signal has an enable logic state and a disable logic state, and wherein the driving signal is at the enable logic state when the first control signal is at the enable logic state and the second control signal is also at the enable logic state, and wherein the driving signal is at the disable logic state when the first control signal is at the disable logic state and/or the second control signal is at the disable logic state; and wherein the driving signal turns the pass device ON when the driving signal is at the enable logic state, and wherein the driving signal turns the pass device OFF when the third control signal is at the disable logic state.

15. The low drop-out voltage regulator of claim 1 further comprising a linear regulator for regulating the output voltage into a second output voltage, wherein the linear regulator comprises:
a transistor having a first transistor terminal, a second transistor terminal and a transistor control terminal wherein the first transistor terminal is configured to receive the output voltage, the second transistor terminal is configured to generate the second output voltage;
a feedback circuit having a feedback input terminal configured to receive the second output voltage, and a feedback output terminal configured to provide a regulator feedback signal related to the second output voltage; and
an amplifier having a first amplifier input terminal configured to receive a reference signal, a second amplifier input terminal configured to receive the regulator feedback signal, and an amplifier output terminal configured to provide a transistor control signal to the transistor control terminal of the transistor, wherein the transistor control signal represents a difference between the second output voltage and the reference signal, and wherein the transistor control signal drives the transistor to generate the second output voltage at the second transistor terminal.

16. An electronic circuit comprising a low drop-out voltage regulator according to claim 1, wherein the electronic circuit further comprises a load configured to receive the output voltage.

17. A method for converting a power supply voltage to a regulated output voltage, comprising:
providing the power supply voltage to a first terminal of a pass device, wherein the pass device further comprises a second terminal and a control terminal; and
controlling the pass device to provide the regulated output voltage at the second terminal; wherein controlling the pass device comprises:
comparing an input signal related to the power supply voltage and/or the output voltage with a predetermined range to generate a driving signal having an enable logic state and a disable logic state, wherein the driving signal is at the enable logic state when the input signal is within the predetermined range, and wherein the driving signal is at the disable logic state when the input signal is without the predetermined range;
providing the driving signal to the control terminal of the pass device; and
turning the pass device ON when the driving signal is at the enable logic state, and turning the pass device OFF when the driving signal is at the disable logic state.

18. The method of claim 17, wherein the input signal comprises the power supply voltage, and wherein the predetermined range comprises a first predetermined range.

19. The method of claim 17, wherein the input signal comprises the output voltage, and wherein the predetermined range comprises a second predetermined range.

20. The method of claim 17, wherein the input signal comprises the power supply voltage and the output voltage, and wherein the predetermined range comprises a first predetermined range and a second predetermined range, and wherein
comparing the input signal with the predetermined range comprises:
comparing the power supply voltage with the first predetermined range to generate a first control signal having an enable logic state and a disable logic state, wherein the first control signal is at the enable logic state when the power supply voltage is within the first predetermined range, and wherein the first control signal is at the disable logic state when the power supply voltage is without the first predetermined range;
comparing the output voltage with the second predetermined range to generate a second control signal having an enable logic state and a disable logic state, wherein the second control signal is at the enable logic state when the regulated output voltage is within the second predetermined range, and wherein the second control signal is at the disable logic state when the regulated output voltage is without the second predetermined range; and
generating the driving signal based on the first control signal and the second control signal, wherein the driving signal is at the enable logic state when the first control signal is at the enable logic state and the second control signal is also at the enable logic state, and wherein the driving signal is at the disable logic state when the first control signal is at the disable logic state and/or the second control signal is at the disable logic state.

21. The method of claim 18, wherein comparing the power supply voltage with the first predetermined range comprises:
comparing the power supply voltage with a first threshold voltage to generate a first control signal having an enable logic state and a disable logic state, wherein the first control signal is at the enable logic state when the power supply voltage is lower than the first threshold voltage, and wherein the first control signal is at the disable logic state when the power supply voltage is higher than the first threshold voltage.

22. The method of claim 21, wherein the first threshold voltage comprises a third threshold voltage and a fourth threshold voltage, wherein the fourth threshold voltage has a first predetermined hysteresis from the third threshold voltage, and wherein the first control signal is at the enable logic state when the power supply voltage is lower than the third threshold voltage, and wherein the first control signal is at the disable logic state when the power supply voltage is higher than the fourth threshold voltage.

23. The method of claim 19, wherein comparing the output voltage with the second predetermined range comprises:
comparing the output voltage with a second threshold voltage to generate the second control signal, wherein the second control signal is at the enable logic state when the regulated output voltage is lower than the second threshold voltage, and wherein the second control signal is at the disable logic state when the regulated output voltage is higher than the second threshold voltage.

24. The method of claim 23, wherein the second threshold voltage comprises a fifth threshold voltage and a sixth threshold voltage, wherein the sixth threshold voltage has a second predetermined hysteresis from the fifth threshold voltage, and wherein the second control signal is at the enable logic state when the output voltage is lower than the fifth threshold voltage, and wherein the second control signal is at the disable logic state when the output voltage is higher than the sixth threshold voltage.
